(19) United States
(12) Patent Application Publication
(10) Pub. No.: US 2024/0386592 A1
(43) Pub. Date: Nov. 21, 2024

(54) DEVICE FOR GENERATING DEPTH MAP, METHOD FOR GENERATING DEPTH MAP, AND NON-TRANSITORY INFORMATION STORAGE MEDIUM STORING PROGRAM FOR GENERATING DEPTH MAP

(71) Applicant: Japan Display Inc., Tokyo (JP)

(72) Inventors: Hitoshi TANAKA, Tokyo (JP); Yoshiro AOKI, Tokyo (JP); Hirondo NAKATOGAWA, Tokyo (JP)

(21) Appl. No.: 18/661,909

(22) Filed: May 13, 2024

(30) Foreign Application Priority Data
May 19, 2023 (JP) 2023-083130

(51) Int. Cl. G06T 7/593; G06T 5/70; G06T 7/11

(52) U.S. Cl. CPC G06T 7/593; G06T 5/70; G06T 7/11; G06T 2207/10012

(57) ABSTRACT

A depth calculating unit calculates a depth for each of a plurality of unit regions (for example, pixels) forming a depth map. A dividing unit divides an image region corresponding to a captured image into a plurality of partial regions. A noise removing unit removes, using a first parameter, noise from estimated depths calculated for a plurality of unit regions included in a first partial region. The noise removing unit removes, using a second parameter, noise from estimated depths calculated for a plurality of unit regions included in a second partial region. This prevents a problem in that an estimated depth that should originally be displayed is excluded from the depth map.

### CROSS-REFERENCE TO RELATED APPLICATION

The present application claims priority from Japanese application JP2023-083130 filed on May 19, 2023, the content of which is hereby incorporated by reference into this application.

### BACKGROUND OF THE INVENTION

### 1. Field of the Invention

The present invention relates to a depth map generation device, a depth map generation method, and a non-transitory information storage medium storing a program for generating a depth map.

### 2. Description of the Related Art

A paper described below proposes a technique for generating a depth map from an image captured through a coded aperture. In the paper, two coded apertures having different aperture patterns (shapes of a light transmitting region and a light blocking region) are used. The two coded apertures are used in combination to prevent a frequency band in which a power spectrum is zero from occurring in a filter (a filter for generating a restored image) used in a process for generating a depth map. “C. Zhou, S. Lin, and S. Nayar: Coded Aperture Pairs for Depth from Defocus, IEEE international conference on computer vision, 2009”

In a process for generating a map, noise determination is necessary for determining whether a dot (a pixel) in a depth map is noise or a dot indicating the distance to a subject. A dot determined as noise needs to be removed from the depth map. However, when the same noise removal processing is applied to an entire region of an image in which a plurality of regions having different natures such as a region with low contrast and a region with high contrast are mixed, the noise removal is sometimes not correctly executed.

### SUMMARY OF THE INVENTION

A depth map generation device proposed in the present disclosure is a depth map generation device for generating a depth map from a captured image captured through a coded aperture. The generation device includes: a depth calculating unit configured to calculate a depth for each of a plurality of unit regions forming the depth map; a dividing unit configured to divide an image region corresponding to the captured image into a plurality of partial regions including at least a first partial region and a second partial region; and a noise removing unit configured to remove, using a first parameter, noise from depths calculated for a plurality of unit regions included in the first partial region, and the noise removing unit being configured to remove, using a second parameter, noise from depths calculated for a plurality of unit regions included in the second partial region.

A depth map generation method proposed in the present disclosure is a method of generating a depth map from a captured image captured through a coded aperture. The generation method includes: a depth calculating step for calculating a depth for each of a plurality of unit regions forming the depth map; a dividing step for dividing an image region corresponding to the captured image into a plurality of partial regions including at least a first partial region and a second partial region; and a noise removing step for removing, using a first parameter, noise from depths calculated for a plurality of unit regions included in the first partial region, and the noise removing step for removing, using a second parameter, noise from depths calculated for a plurality of unit regions included in the second partial region.

A program proposed in the present disclosure is a program for causing a computer to function as a device for generating a depth map from a captured image captured through a coded aperture. The program causes the computer to function as: depth calculating means for calculating a depth for each of a plurality of unit regions forming the depth map; dividing means for dividing an image region corresponding to the captured image into a plurality of partial regions including at least a first partial region and a second partial region; and noise removing means for removing, using a first parameter, noise from depths calculated for a plurality of unit regions included in the first partial region, and the noise removing means for removing, using a second parameter, noise from depths calculated for a plurality of unit regions included in the second partial region.

With the depth map generation device, the depth map generation method, and the program proposed in the present disclosure, it is possible to prevent a problem in that an estimated depth that should originally be displayed is removed from a depth map.

### BRIEF DESCRIPTION OF THE DRAWINGS

FIG. 1 is a sectional view illustrating an example of an imaging system of a depth map generation device;

FIG. 2 is a block diagram illustrating hardware of the depth map generation device;

FIG. 3 is a block diagram illustrating functions of a control unit included in the depth map generation device;

FIG. 4A is a diagram illustrating an example of a first aperture pattern of a coded aperture;

FIG. 4B is a diagram illustrating a second aperture pattern of the coded aperture;

FIG. 5 is a flowchart illustrating an example of processing executed by the control unit;

FIG. 6 is a diagram for explaining a deviation value map;

FIG. 7 is a diagram for explaining estimated depth calculation processing;

FIG. 8 is a diagram for explaining noise removal processing;

FIG. 9A is a diagram for explaining an example of processing for dividing an image region corresponding to a captured image;

FIG. 9B is a diagram illustrating an example of a depth map;

FIG. 10 is a diagram for explaining a modification of the noise removal processing; and

FIG. 11 is a flowchart illustrating another example of the processing executed by the control unit.

### DETAILED DESCRIPTION OF THE INVENTION

A depth map generation device, a depth map generation method, and a program proposed in the present disclosure are explained below.

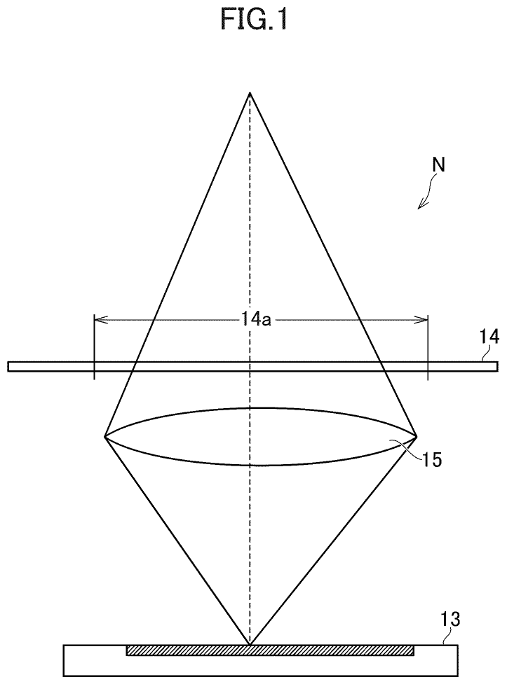

FIG. 1 is a sectional view illustrating an imaging system N of a generation device 10 that is an example of a depth map generation device proposed in the present disclosure. As illustrated in FIG. 1, the generation device 10 includes a liquid crystal panel 14 and an imaging element 13.

The imaging element 13 is an image sensor such as a CMOS (Complementary Metal Oxide Semiconductor) sensor or a CCD (Charge Coupled Device).

The liquid crystal panel 14 includes a plurality of pixels. The liquid crystal panel 14 includes a coded aperture 14a in a part thereof. A control unit 11 explained below drives liquid crystal of the coded aperture 14a to form an aperture pattern specified in advance. The aperture pattern is explained in detail below.

As illustrated in FIG. 1, the generation device 10 includes a lens 15 disposed between the coded aperture 14a and the imaging element 13. Light having passed through the coded aperture 14a and the lens 15 is made incident on the imaging element 13.

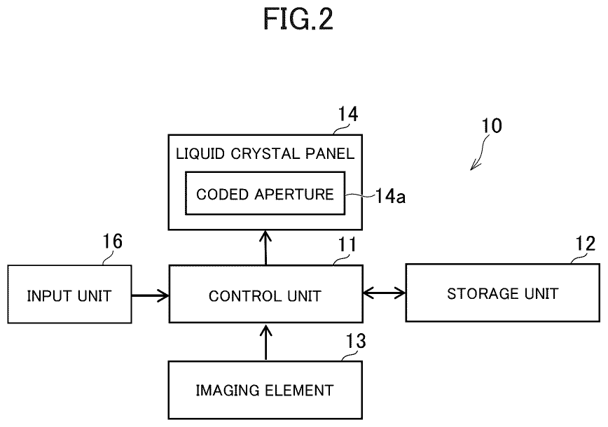

FIG. 2 is a block diagram illustrating hardware of the depth map generation device 10. The generation device 10 includes the control unit 11, a storage unit 12, and an input unit 16 besides the liquid crystal panel 14, the imaging element 13, and the lens 15 illustrated in FIG. 1.

The control unit 11 includes at least one processor such as a CPU (Central Processing Unit) or a GPU (Graphical Processing Unit). Image data acquired by the imaging element 13 is provided to the control unit 11. The control unit 11 generates, using the image data, a depth map indicating the distance to a subject.

The storage unit 12 includes a main storage unit and an auxiliary storage unit. For example, the main storage unit is a volatile memory such as a RAM (Random Access Memory). The auxiliary storage unit is a nonvolatile memory such as a ROM (Read Only Memory), an EEPROM (Electrically Erasable and Programmable Read Only Memory), a flash memory, or a hard disk. The control unit 11 executes a program stored in the storage unit 12 to control the liquid crystal panel 14 and calculate a depth (the distance to the subject). Processing executed by the control unit 11 is explained below. The generation device 10 may be a portable device such as a smartphone or a tablet PC (Personal Computer) or may be a personal computer connected to a camera.

The input unit 16 may be a touch sensor attached to an image display device that displays a captured image. The input unit 16 may be a keyboard or a pointing device such as a mouse. The input unit 16 inputs a signal corresponding to operation of a user to the control unit 11.

### Functional Blocks

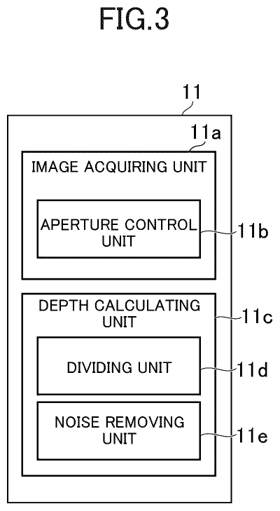

FIG. 3 is a block diagram illustrating functions included in the control unit 11. The control unit 11 includes, as the functions, an image acquiring unit 11a and a depth calculating unit 11c. The image acquiring unit 11a includes an aperture control unit 11b. The depth calculating unit 11c includes a dividing unit 11d and a noise removing unit 11e. These functions are implemented by the control unit 11 operating according to a program stored in the storage unit 12.

### Aperture Control Unit

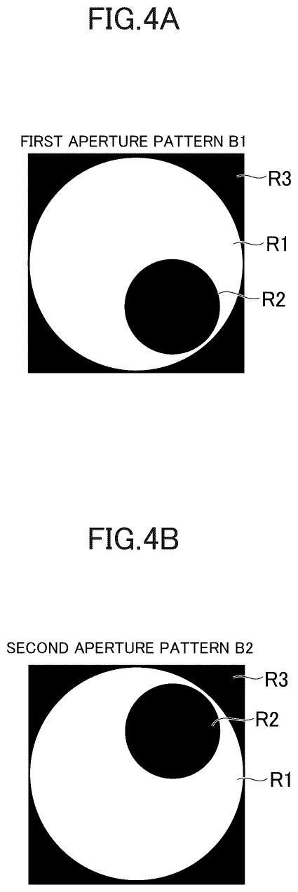

The aperture control unit 11b controls liquid crystal of the coded aperture 14a of the liquid crystal panel 14 to form an aperture pattern specified in advance. FIGS. 4A and 4B are diagrams illustrating examples of aperture patterns formed by the coded aperture 14a. In the figures, a white region is a light transmitting region R1 and black regions are light blocking regions R2 and R3.

In aperture patterns B1 and B2 illustrated in FIGS. 4A and 4B, the light transmitting region R1 having a circular shape is formed on the inner side of the light blocking region R3 having a rectangular shape. The light blocking region R2 having a circular shape is formed on the inner side of the light transmitting region R1. The light blocking region R2 of a first aperture pattern B1 and the light blocking region R2 of a second aperture pattern B2 are formed in different positions. In the examples illustrated in FIGS. 4A and 4B, the two light blocking regions R2 are formed in symmetrical positions. With the two aperture patterns B1 and B2, as explained in the paper described above, in a spatial frequency characteristic of a point spread function corresponding to an aperture pattern, it is possible to prevent occurrence of a frequency band in which a power spectrum is zero. The aperture patterns B1 and B2 can be searched by, for example, a genetic algorithm. The aperture pattern formed by the aperture control unit 11b is not limited to the examples illustrated in FIGS. 4A and 4B.

### Image Acquiring Unit

The image acquiring unit 11a controls the imaging element 13 and the coded aperture 14a and continuously captures two images f₁ and f₂ using the two aperture patterns B1 and B2. (In the following explanation, the images f₁ and f₂ are referred to as captured images). At this time, an interval between the imaging by the first aperture pattern B1 and the imaging by the second aperture pattern B2 may be several hundred milliseconds or several ten milliseconds.

Note that the number of aperture patterns formed by the aperture control unit 11b may be larger than two. In this case, the image acquiring unit 11a may continuously capture images by the number of aperture patterns larger than two. The aperture control unit 11b switches a plurality of aperture patterns in order while synchronizing with light reception by the imaging element 13.

### Depth Calculating Unit

The depth calculating unit 11c generates a depth map from the captured images f₁ and f₂ acquired by the image acquiring unit 11a. The depth calculating unit 11c calculates, for each of a plurality of unit regions forming the depth map, depths (the distances from the imaging system N to the subject) of the captured images f₁ and f₂. The unit region of the depth map may be formed of, for example, one pixel in the captured images f₁ and f₂ . In contrast to this, the unit region of the depth map may be larger than one pixel in the captured images. For example, a plurality of adjacent pixels (for example, 2×2) may form the unit region.

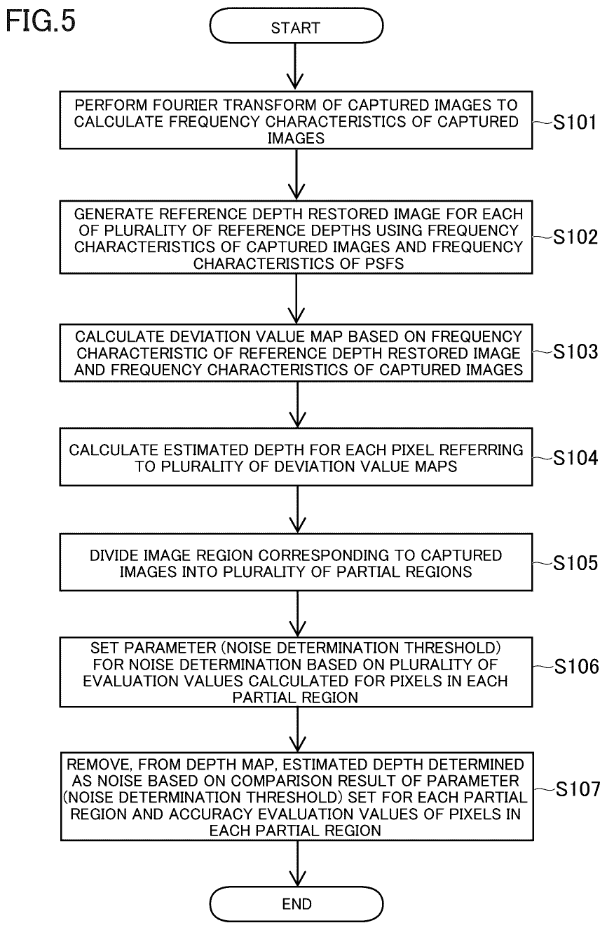

FIG. 5 is a flowchart illustrating an example of processing of the depth calculating unit 11c. The processing of the depth calculating unit 11c illustrated in FIG. 5 is started after the captured images f₁ and f₂ were acquired by the image acquiring unit 11a.

First, the depth calculating unit 11c performs two-dimensional Fourier transform of the captured images f₁ and f₂ (S101). In the following explanation, frequency characteristics of the captured images f₁ and f₂ obtained by the two-dimensional Fourier transform are represented as F₁ and F₂. That is, F₁ and F₂ is are the results of the two-dimensional Fourier transform executed for the captured images f₁ and f₂, respectively. Note that, if a high frequency component is included in an image, the influence of noise is sometimes excessively large when a “reference depth restored image” is calculated. Therefore, high frequency components may be removed from the frequency characteristics F₁ and F₂. For example, a low pass filter that transmits only a frequency equal to or lower than a half (a Nyquist frequency) of a sampling frequency may be used. The frequency characteristics Fi and Fe from which the high-frequency components are removed may be used in processing explained below.

### Generation of a Reference Depth Restored Image

In the generation device 10, a plurality of point spread functions (PSFs) are prepared, which respectively corresponding to a plurality of reference depths that is defined discretely. The reference depths are candidate values of the distance to the subject such as 100 mm, 300 mm, and 700 mm. Each PSF has a shape corresponding to the aperture patterns B1 and B2 of the coded aperture 14a (expressing the aperture patterns B1 and B2). Each PSF has a size corresponding to the reference depth corresponding thereto. Specifically, the size of the PSF decreases as the reference depth increases. The storage unit 12 stores frequency characteristics obtained by performing two-dimensional Fourier transform of the plurality of PSFs. The depth calculating unit 11c acquires, as the PSF, the frequency characteristic from the storage unit 12. The frequency characteristic is referred to as optical transfer function (OTF) as well.

The depth calculating unit 11c generates a restored image corresponding to the reference depth for each of the plurality of reference depths, by using the captured images f₁ and f₂ and the PSFs (S102). In the following explanation, the restored image is referred to as “reference depth restored image”. The depth calculating unit 11c calculates, specifically, by using the following Math. 1, a frequency characteristic of a reference depth restored image to corresponding the frequency characteristics F₁ and F₂ of the captured images f₁ and f₂ and the frequency characteristics of the PSFs.

$${F}_{0 \_ d} = \frac{{F}_{1} \cdot {\overline{K}}_{1 \_ d} + {F}_{2} \cdot {\overline{K}}_{2 \_ d}}{\vert {K}_{1 \_ d} {\vert}^{2} + \vert {K}_{2 \_ d} {\vert}^{2} + \vert C {\vert}^{2}} \qquad [ Math . 1 ]$$

Math. 1 is a Wiener filter generalized to be applicable to the two aperture patterns B1 and B2. In Math 1, characters means the following elements.
F_{o_d}: A reference depth restored image represented in a frequency domain, that is a frequency characteristic of the reference depth restored image
F₁: A frequency characteristic of the captured image f₁ obtained by the first aperture pattern B1
F₂: A frequency characteristic of the captured image f₂ obtained by the second aperture pattern B2
K_{1_d}: A frequency characteristic (an optical transfer function) of a PSF having a shape corresponding to the first aperture pattern B1, the PSF corresponding to a size of a reference depth (d)
K_{2_d}: A frequency characteristic (an optical transfer function) of a PSF having a shape corresponding to the second aperture pattern B2, the PSF corresponding to the size of the reference depth (d)
C: A matrix of an S/N ratio and a regularization term considering noise due to fluctuation. C can be calculated according to, for example, variance σ of image noise and a frequency distribution S of a natural image.
K_{1_d} bar, K_{2_d} bar (K_{1_d}, K_{2_d} with overlines): Conjugate complex numbers of the frequency characteristics K_{1_d} and K_{2_d} of PSFs

The sizes of the PSFs decrease as the distance (the depth) from the imaging system N to the subject increases. For that reason, the frequency characteristics K_{1_d} and K_{2_d} a of the PSFs are also defined according to the distance from the imaging system N to the subject. In Math. 1, a subscript “d” added to K₁ and K₂ corresponds to a reference depth such as 100 mm or 300 mm. For example, functions K_{1_100} and K_{2_100} are frequency characteristics (optical transfer functions) of a point spread function for a subject which is distant at 100 mm from the imaging system N. The number of reference depths may be larger than two and may be, for example, ten, twenty, or thirty.

In S102, the depth calculating unit 11c calculates, using Math. 1, a frequency characteristic F_{0_d} of a reference depth restored image corresponding to the two frequency characteristics F₁ and F₂ of the captured images f₁ and f₂ and the frequency characteristics K_{1_d} and K_{2_d} of the PSFs. The depth calculating unit 11c calculates, for each of a plurality of reference depths (d), the frequency characteristic F_{0_d} of the reference depth restored image. For example, the depth calculating unit 11c calculates a frequency characteristic F_{0_100} of the reference depth restored image based on the frequency characteristics K_{1_100} and K_{2_100} and the frequency characteristics F₁ and F₂ of the captured images f₁ and f₂. Further, the depth calculating unit 11c calculates a frequency characteristic F_{0_300} of the reference depth restored image based on the frequency characteristics K_{1 300} and K_{2 300} and the frequency characteristics F₁ and F₂ of the captured images f₁ and f₂. The depth calculating unit 11c executes the same calculations for the other frequency characteristics K_{1_700}, K_{2_700}, K_{1_1000}, K_{2_1000}, or the like.

According to Math. 1, a subject, the distance of which from the imaging system N is equal to the reference depth, appears in a state without blur in the reference depth restored image. For example, a subject placed at 100 mm from the imaging system N appears in a state without blur in the reference depth restored image obtained by the frequency characteristics K_{1_100} and K_{2_100}. On the other hand, in a reference depth restored image obtained by the frequency characteristics K_{1_d} and K_{2_d} of PSFs corresponding to other reference depths such as 300 mm or 700 mm, blur (deviation of a pixel value) appears in the same subject. The blur more strongly appears as the difference between an actual depth of the subject and the reference depth increases. Therefore, in the following processing, the depth calculating unit 11c calculates the distance (the depth) to the subject by using a degree of the blur.

### Calculation of a Deviation Value Map

The depth calculating unit 11c calculates a deviation value map M_{d} based on the frequency characteristic F_{0_d} of the reference depth restored image and the frequency characteristics F₁ and F₂ of the captured images f₁ and f₂ (S103). The deviation value map M_{d} is calculated for each of the plurality of reference depths (d). In the deviation value map M_{d}, a deviation degree (a deviation value) between the reference depth (d) and the actual depth is indicated at each pixel (each unit region of the depth map).

The depth calculating unit 11c calculates the deviation value map M_{d}, for example, referring to the following Math. 2.

$${M}_{d} = \vert IFFT ( {F}_{{0}_{\_ d}} * {K}_{1 \_ d} - {F}_{1} ) + ( {F}_{{0}_{\_ d}} * {K}_{{2}_{\_ d}} - {F}_{2} ) \vert \qquad [ Math . 2 ]$$

In Math. 2, characters mean the following elements.
M_{d}: A deviation value map for the reference depth (d)
IFFT: A two-dimensional inverse Fourier transform
F_{0_d}: A frequency characteristic of the reference depth restored image for the reference depth (d)
K_{1_d}: A frequency characteristic (an optical transfer function) of a PSF having a shape corresponding to the first aperture pattern B1, the PSF corresponding to the size of the reference depth (d)
K_{2_d}: A frequency characteristic (an optical transfer function) of a PSF having a shape corresponding to the second aperture pattern B2, the PSF corresponding to the size of the reference depth (d)

F₁: A frequency characteristic of the captured image f₁ obtained by the first aperture pattern B1

F₂: A frequency characteristic of the captured image f₂ obtained by the second aperture pattern B2

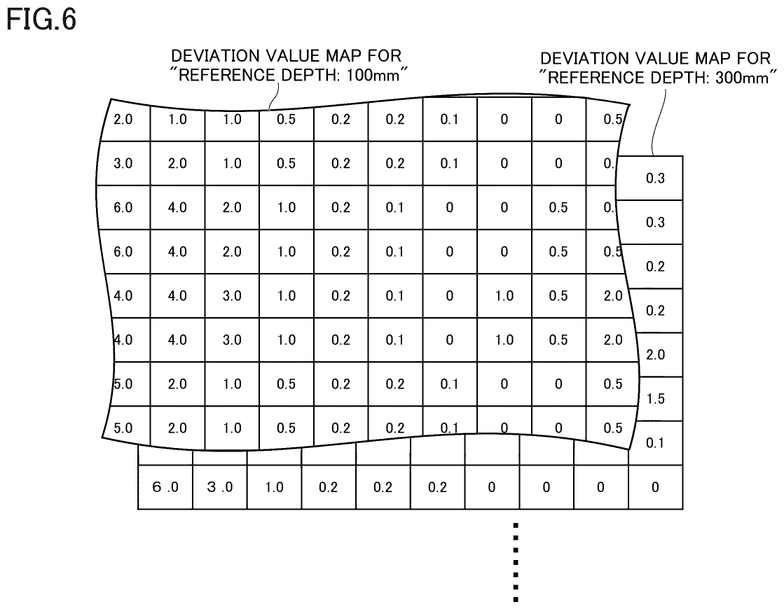

FIG. 6 is a diagram illustrating an example of the deviation value map M_{d}. As illustrated in FIG. 6, the deviation value map M_{d} shows, for each pixel, a deviation value w between an actual depth (the actual distance from the imaging system N to the subject) and a reference depth. For example, a deviation value map M₁₀₀ indicates the deviation value w between the actual depth and a reference depth (100 mm). If the actual depth is 100 mm, a deviation value w₁₀₀ indicated in the deviation value map M₁₀₀ is substantially zero. If the actual depth is 200 mm, the deviation value w₁₀₀ is a value larger than zero in the deviation value map M₁₀₀ corresponding to the reference depth (100 mm). The deviation value maps M_{d} are calculated for the other reference depths, such as 300 mm, 700 mm, or the like.

As explained above, in the processing in S102, the depth calculating unit 11c generates, respectively using a plurality of the frequency characteristics K_{1_d} and K_{2_d} expressing PSFs defined for the reference depths (d), a plurality of reference depth restored images (more specifically, frequency characteristics F_{0_d} thereof) from the captured images f₁ and f₂ (more specifically, the frequency characteristics F₁ and F₂ thereof). In S103, the depth calculating unit 11c calculates a deviation value w_{d} between the reference depth (d) and the actual depth, by using the plurality of reference depth restored images represented by the frequency characteristics F_{0_d} and the frequency characteristics F₁ and F₂ expressing the captured images f₁ and f₂.

### Calculation of a Depth of Each Unit Region

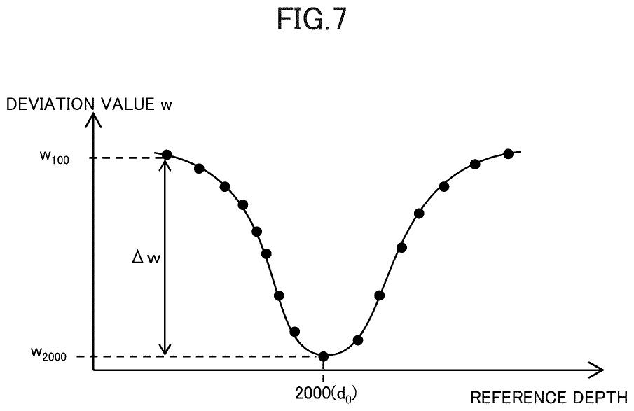

The depth calculating unit 11c calculates a depth (the distance from the imaging system N to the subject) for each pixel (the unit region of the depth map), by referring to a plurality of deviation value maps Ma (S104). FIG. 7 is a diagram for explaining this processing by the depth calculating unit 11c. In FIG. 7, the horizontal axis indicates the reference depth and the vertical axis indicates the deviation value w_{d} in a certain pixel. In the following explanation, a depth calculated by the depth calculating unit 11c is referred to as estimated depth d₀.

The deviation value w_{d} is the smallest at the reference depth (d) that is the same as the actual depth or close to the actual depth. In the example illustrated in FIG. 7, the deviation value w_{d} is the smallest in a position where the reference depth is 2000 mm. Therefore, the subject appearing in the one pixel is estimated as being located in the position of 2000 mm from the imaging system N. Therefore, in S104, the depth calculating unit 11c searches for a reference depth at which the deviation value w_{d} is the smallest and sets the obtained reference depth as the estimated depth d₀. The depth calculating unit 11c executes the search for all the pixels (all the unit regions of the depth map), whereby the depth map before noise removal is performed explained below is obtained.

Note that depth map calculation processing is not limited to the explained above. In the processing explained above, the depth calculating unit 11c sets, as the estimated depth d₀ of the pixel, the reference depth (d) of the deviation value map M_{d} that minimizes the deviation value w_{d}. In contrast to this, the depth calculating unit 11c may calculate a function indicating a relation between a depth and the deviation value w_{d}, and then calculate a minimum value by using the function. The depth calculating unit 11c may calculate, as the estimated depth d₀ of the pixel, a depth at which the minimum value is obtained.

This processing by the depth calculating unit 11c can be performed, for example, as explained below. The depth calculating unit 11c fits, for example, a cubic function to the relation between the reference depth (d) and the deviation value w_{d} illustrated in FIG. 7. That is, the depth calculating unit 11c fits the following Math. 3 to a point where the minimum of the deviation value w_{d} is obtained and a plurality of points in the vicinity of the point and then calculates coefficients a1, a2, a3, and a4. In Math. 3, a function W (d) is a cubic function having a1, a2, a3, and a4 as coefficients.

$$w ( d ) = {a}_{1} \cdot {d}^{3} + {a}_{2} \cdot {d}^{2} + {a}_{3} \cdot d + {a}_{4} \qquad [ Math . 3 ]$$

The depth calculating unit 11c calculates a minimum of Math. 3. That is, the depth calculating unit 11c solves δW/δd=0 to calculate a depth for minimizing the function W (d). The depth calculating unit 11c sets, as the estimated depth d₀, the depth calculated in this way. With the processing explained above, it is possible to increase the resolution for the depth without increasing the number of reference depths (the number of PSFs).

### Accuracy Evaluation Value

With Math. 2 explained above, the estimated depth d₀ is calculated for a position where blur occurs by executing convolutional integration based on PSFs. For example, the estimated depth d₀ is calculated in the boundary between the outer edge of the subject and a background (That is, the estimated depth d₀ is calculated for a position where change in pixel values appears). On the other hand, it is difficult to estimate an accurate depth for a region where blur does not occur by executing convolutional integration based on PSFs. In the region where blur does not occur, the change in the deviation value w_{d} dependent on the reference depths is small because change in pixel values is small (that is, the contrast in the pixels is low). In other words, the estimated depth d₀ obtained for a pixel having small change in the deviation value w_{d} is likely to be noise. Therefore, the depth calculating unit 11c determines such an estimated depth d₀ as noise and removes the estimated depth d₀ from the depth map obtained in S104. The processing of the depth calculating unit 11c is performed, for example, as explained below.

The depth calculating unit 11c calculates, based on the deviation value w_{d} calculated for each pixel (the unit region of the depth map), an accuracy evaluation value indicating accuracy of the estimated depth d₀ obtained for the pixel. For example, the depth calculating unit 11c calculates the accuracy evaluation value based on the widths of changes in a plurality of deviation values w_{d} calculated for each pixel. The depth calculating unit 11c calculates accuracy evaluation values for all the pixels. The accuracy evaluation value is represented by, for example, Math. 4 explained below.

$$β = Δ w \times {d}_{0} \qquad [ Math . 4 ]$$

β: The accuracy evaluation value
Δw: A change amount of the deviation value w_{d}
d₀: The depth of each pixel obtained by the processing in S104

The change amount Δw is the width of the change in the deviation value w_{d}. The change amount Δw is, for example, as illustrated in FIG. 7, the difference between a maximum and a minimum of the deviation value w_{d} in each pixel. As indicated by Math. 4, the depth calculating unit 11c calculates the accuracy evaluation value based on the differences between maximums and minimums of the plurality of deviation values w_{d}.

In general, a wrong estimated result is often obtained for a subject located at a short distance due to noise or the like. Therefore, as shown in Math. 4, the accuracy evaluation value β may be a result of weighting the change amount Δw by the estimated depth d₀ so that the change amount Δw is evaluated as small amount for the subject (so that the change amount Δw is likely to be removed as a noise).

The depth calculating unit 11c determines, as noise, the estimated depth d₀ obtained for a pixel having the accuracy evaluation value β lower than a noise determination threshold and removes the estimated depth d₀ from the depth map. In other words, the depth calculating unit 11c displays, on the depth map, only the estimated depth d₀ obtained for a pixel having the accuracy evaluation value β higher than the noise determination threshold.

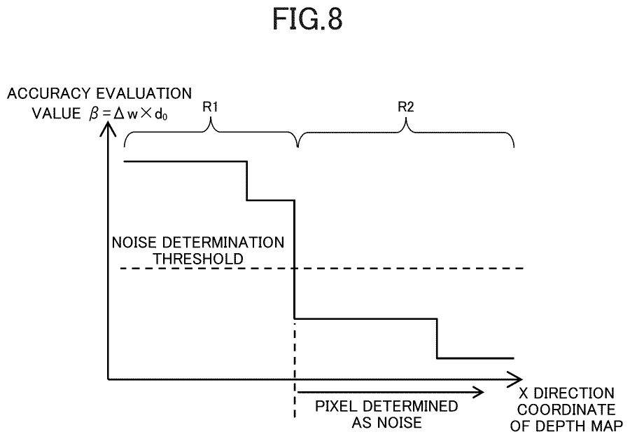

FIG. 8 is a diagram for explaining the processing of the depth calculating unit 11c. In FIG. 8, the horizontal axis indicates an X direction coordinate of the depth map and the vertical axis indicates the accuracy evaluation value B. In FIG. 8, since the change amount Δw of the deviation value w_{d} is relatively large in a pixel group in the region R1, the accuracy evaluation value β of the pixel group is higher than a noise determination threshold Nth. On the other hand, since the change amount Δw of the deviation value w_{d} is relatively small in a pixel group in the region R2, the accuracy evaluation value β of the pixel group is lower than the noise determination threshold Nt. In this case, the depth calculating unit 11c displays, on the depth map, the depth d₀ calculated for the pixel group in the region R1 and, on the other hand, does not display, on the depth map, the depth d₀ calculated for the pixel group in the region R2.

When the processing illustrated in FIG. 8 is performed, a problem is how to set the noise determination threshold Nth. A maximum value among accuracy evaluation values β calculated for all the pixels multiplied by a predetermined percentage (for example, 50%) can be conceived as an example of the noise determination threshold Nth. However, if the noise determination threshold Nth is used, a problem occurs in that the estimated depth d₀ that should originally be displayed on the depth map is determined as noise. For example, when a captured image partially includes a dark region, the change amount Δw of the deviation value w_{d} in the dark region is small. For that reason, the accuracy evaluation value β calculated for the region described above is smaller than the noise determination threshold Nth. As a result, the estimated depth d₀ of the region is excluded from the depth map.

Therefore, the depth calculating unit 11c divides an image region corresponding to the captured image into a plurality of partial regions. The depth calculating unit 11c executes noise removal processing for the plurality of partial regions respectively using a plurality of parameters different from one another. In the following explanation, the noise removal processing is specifically explained.

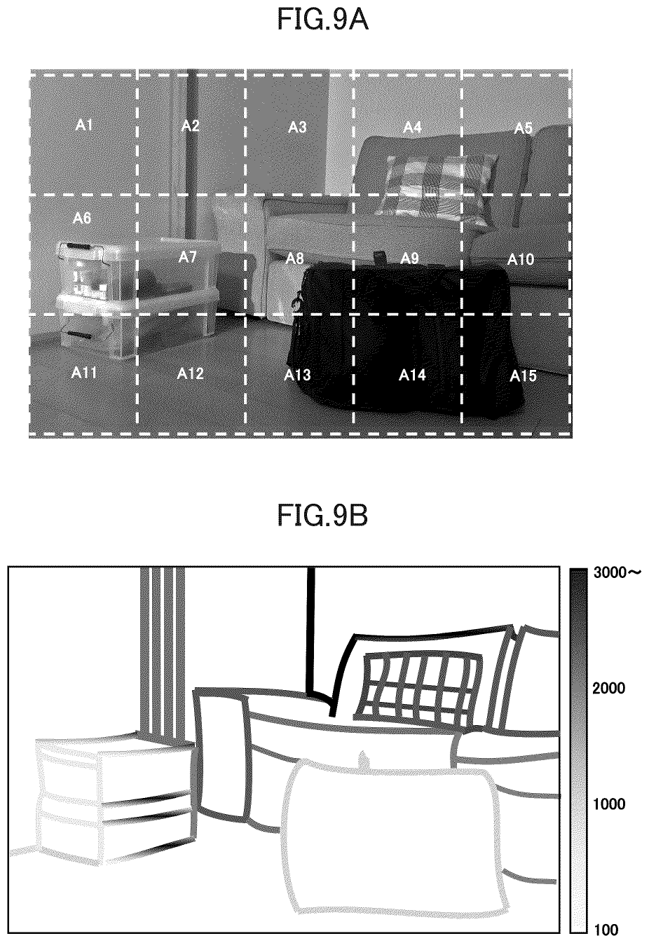

The dividing unit 11d divides an image region corresponding to the captured images f₁ and f₂ into a plurality of partial regions. For example, the dividing unit 11d divides the depth map before noise removal calculated in S104 into a plurality of partial regions (S105). FIG. 9A is a diagram for explaining an example of processing of the dividing unit 11d. In FIG. 9A, a captured image on which the depth map is based is illustrated. As illustrated in FIG. 9A, the dividing unit 11d divides the depth map before noise removal into, for example, a plurality of partial regions specified in advance. More specifically, the dividing unit 11d divides the depth map before noise removal into a plurality of rectangular partial regions having a size specified in advance.

### Noise Removal

The noise removing unit 11e removes, using a first parameter set for a first partial region A1 (see FIG. 9A), noise from the estimated depth d₀ calculated for pixels included in the first partial region A1. Similarly, the noise removing unit 11e removes, using a second parameter set for a second partial region A2 (see FIG. 9A), noise from the estimated depth d₀ calculated for pixels included in the second partial region A2. The noise removing unit 11e executes the processing explained above for each of a plurality of partial regions A1 to A15 (see FIG. 9A). With the processing explained above, the noise removal is executed using a parameter suitable for each partial region. As a result, it is possible to prevent the problem in that the estimated depth d₀ that should originally be displayed is excluded from the depth map.

The processing of the noise removing unit 11e is performed, for example, as explained below. After the dividing unit 11d has executed the division processing, first, the noise removing unit 11e sets a parameter for noise determination based on a plurality of accuracy evaluation values β calculated for pixels in each partial region (S106). For example, the noise removing unit 11e calculates a maximum value of the accuracy evaluation values β calculated for a plurality of pixels in each partial region. The noise removing unit 11e multiplies the maximum value of the accuracy evaluation values β by a predetermined percentage (A %) and sets a result of the multiplication (β×A %) as a parameter (a noise determination threshold) used in noise determination for the partial region. The noise removing unit 11e calculates a noise determination threshold for each of the plurality partial regions A1 to A15 (see FIG. 9A). A method of calculating a noise determination value may be changed as appropriate.

Subsequently, the noise removing unit 11e compares the parameter (the noise determination value) set for each partial region and the accuracy evaluation value β of each pixel included in each partial region and removes, from the depth map, the estimated depth d₀ determined as noise based on a result of the comparison (S107). For example, the noise removing unit 11e determines, as noise, the estimated depth d₀ calculated for a pixel having the accuracy evaluation value β lower than the noise determination threshold and removes the estimated depth d₀ from the depth map. The noise removing unit 11e executes the noise removal processing in S107 for each of the plurality of partial regions A1 to A15 (see FIG. 9A). This makes it possible to obtain the depth map exemplified in FIG. 9B.

As explained above, the noise removing unit 11e determines whether the estimated depths d₀ of the pixels in each partial regions are noise, based on the accuracy evaluation value β calculated for each pixel within the plurality of partial regions and the parameter (the noise determination threshold) set for each of the partial regions A1 to A15.

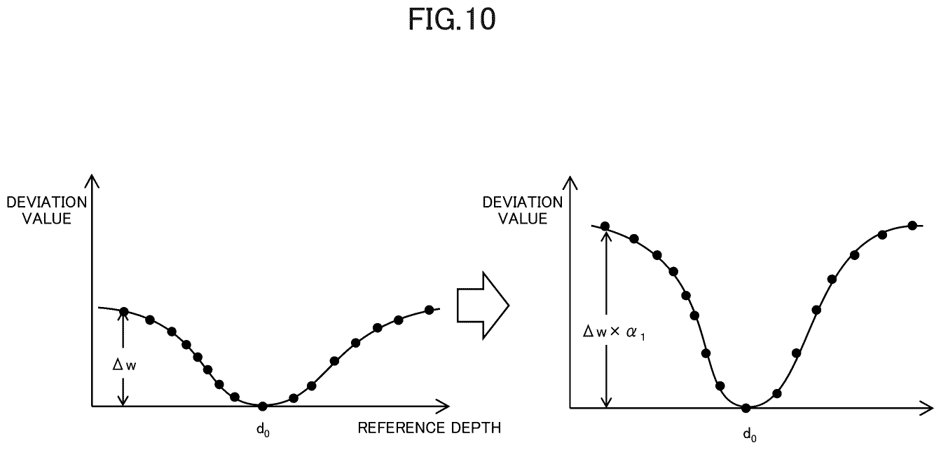

Note that the processing of the noise removing unit 11e is not limited to the example explained here. For example, the parameter set for each of the partial regions A1 to A15 may not be the noise determination threshold. FIG. 10 is a diagram for explaining a modification of the noise removing unit 11e. As illustrated in FIG. 10, for example, the noise removing unit 11e multiplies the change amount Δw of the deviation value w calculated for each pixel of the first partial region A1 (see

FIG. 9A) by a first parameter α₁ set for the first partial region A1. Further, the noise removing unit 11e may multiply the change amount Δw multiplied by the first parameter α₁ by the estimated depth d₀ calculated for each pixel and set a result of the multiplication (Δw×d₀×α₁) as the accuracy evaluation value β.

The noise removing unit 11e may compare the accuracy evaluation value α and the noise determination threshold Nth common to the plurality of partial regions. When the accuracy evaluation value β is lower than the noise determination threshold, the noise removing unit 11e may remove the estimated depth d₀ of the pixel from the depth map. The noise removing unit 11e may execute the processing explained above for each of the plurality of partial regions A1 to A15.

In this case, parameters α1 to α15 applied to the partial regions A1 to A15 may be set based on contrasts of the partial regions. For example, in a partial region having small contrast (for example, a region where the entire partial region is dark), a relatively large parameter may be used. More specifically, the parameter for the partial region having small contrast (for example, the region where the entire partial region is dark) may be set so that a maximum of change amounts Δw of deviation values w of a plurality of pixels in the partial region having relatively small contrast coincides with a maximum of change amounts Δw of deviation values w of pixels in a partial region having relatively large contrast. With the processing explained above as well, it is possible to prevent the problem in that the estimated depth d₀ that should originally be displayed is excluded from the depth map.

### Summary

(1) In the generation device 10, the depth calculating unit 11c calculates a depth for each of a plurality of unit regions (for example, pixels) forming a depth map. The dividing unit 11d divides an image region corresponding to a captured image into the plurality of partial regions A1 to A15. The noise removing unit 11e removes, using a first parameter, noise from the estimated depths d₀ calculated for a plurality of unit regions included in the first partial region A1. The noise removing unit 11e removes, using a second parameter, noise from the estimated depths d₀ calculated for a plurality of unit regions included in the second partial region A2. With the generation device 10, it is possible to prevent a problem in that the estimated depth d₀ that should originally be displayed is excluded from the depth map.
(2) In (1), the noise removing unit 11e calculates the accuracy evaluation value β indicating accuracy of the estimated depth d₀ calculated for each unit region. The noise removing unit 11e determines, based on the first parameter and the accuracy evaluation value β calculated for each unit region in the first partial region A1, whether the estimated depth d₀ calculated for each unit region of the first partial region A1 is noise. The noise removing unit 11e determines, based on the second parameter and the accuracy evaluation value β calculated for each unit region in the second partial region A2, whether the estimated depth d₀ calculated for each unit region of the second partial region A2 is noise. This makes it possible to remove the estimated depth d₀ having low accuracy from the depth map.
(3) In (2), the first parameter and the second parameter are noise determination thresholds. The noise removing unit 11e determines, based on a comparison result between the first parameter and an accuracy evaluation value calculated for each unit region in the first partial region A1, whether the estimated depth d₀ calculated for each unit region of the first partial region A1 is noise. The noise removing unit 11e determines, based on a comparison result between the second parameter and an accuracy evaluation value calculated for each unit region in the second partial region A2, whether the estimated depth d₀ calculated for each unit region of the second partial region A2 is noise. This makes it possible to remove the estimated depth d₀ having a low accuracy evaluation value from the depth map.
(4) In (2) or (3), the noise removing unit 11e sets the first parameter based on a plurality of accuracy evaluation values β calculated for the plurality of unit regions in the first partial region A1. Similarly, the noise removing unit 11e sets the second parameter based on a plurality of accuracy evaluation values β calculated for the plurality of unit regions in the second partial region A2. This makes it possible to change parameters for a partial region where pixels having low accuracy evaluation values are clustered and a partial region where pixels having high accuracy evaluation values are clustered.
(5) In (1) to (4), the depth calculating unit 11c acquires a plurality of Point Spread Functions (PSFs) respectively corresponding to an aperture pattern of the coded aperture and corresponding to a plurality of reference depths that is defined discretely. The depth calculating unit 11c calculates a deviation value for each unit region based on the captured image and a plurality of reference depth restored images (S103), where the deviation value represents a deviation degree between the reference depth and an actual depth, and the plurality of reference depth restored images is reproduced from the captured image respectively using the plurality of PSFs. The depth calculating unit 11c calculates the estimated depth d₀ for each unit region based on the deviation value w_{d} (S104).
(6) In (5), the noise removing unit 11e calculates the accuracy evaluation value β indicating accuracy of the estimated depth d₀ calculated for each unit region, based on the deviation value w_{d} calculated for each unit region.
(7) In (5) or (6), the deviation values w_{d} calculated for each unit region are values that change dependent on the reference depths, and the noise removing unit 11e calculates the accuracy evaluation value β based on the widths of changes in the deviation values calculated for each unit region.
(8) In (5) to (7), the noise removing unit 11e sets the first parameter based on a plurality of accuracy evaluation values β calculated for the plurality of unit regions in the first partial region A1 and sets the second parameter based on a plurality of accuracy evaluation values β calculated for the plurality of unit regions in the second partial region A2.

### Other Examples

Note that the depth map generation device, the depth map generation method, and the program proposed in the present disclosure are not limited to the examples explained above.

In the examples explained above, as illustrated in FIG. 4, after the estimated depth d₀ was calculated for each pixel, the image region corresponding to the captured images f₁ and f₂ is divided into the plurality of partial regions A1 to A15. However, in contrast to this, before calculating the estimated depth d₀, the control unit 11 may divide the image region corresponding to the captured images f₁ and f₂ into the plurality of partial regions A1 to A15. The control unit 11 may execute the processing in S101 to S104 illustrated in FIG. 4 for each of the divided partial regions A1 to A15.

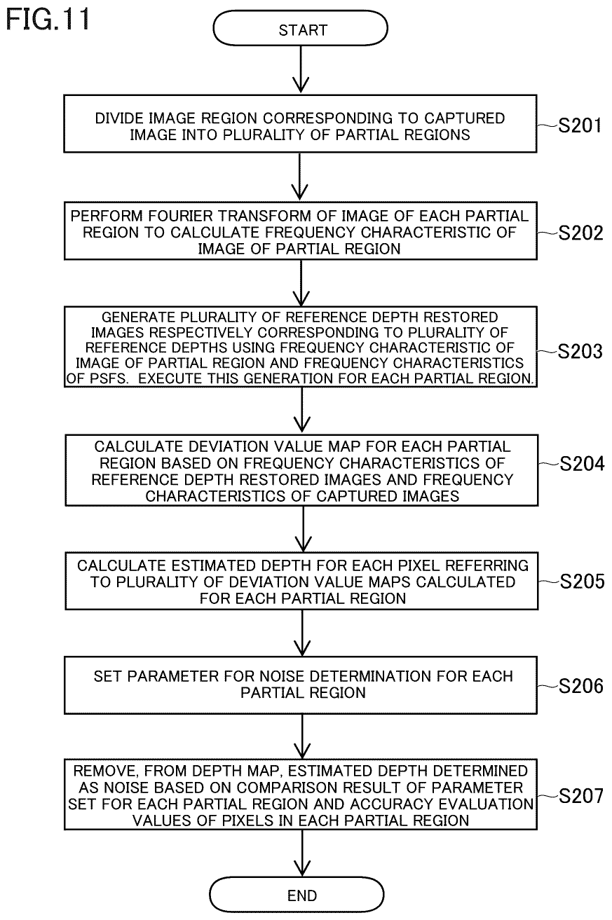

FIG. 11 is a flowchart illustrating an example of the processing explained above.

First, after the captured images f₁ and f₂ are acquired, the dividing unit 11d divides each of the captured images f₁ and f₂ into the plurality of partial regions A1 to A15 (S201). For example, as explained with reference to FIG. 9A, the partial regions A1 to A15 may be rectangular regions having a size specified in advance. Subsequently, the depth calculating unit 11c performs two-dimensional Fourier transform of each of the plurality of partial regions A1 to A15 and calculates a frequency characteristic of each of the partial regions A1 to A15 (S202). Subsequently, the depth calculating unit 11c generates, using Math. 1, for each of a plurality of reference depths (d), a reference depth restored image corresponding to an image of each partial region represented by the frequency characteristic and PSFs represented by the frequency characteristics K_{1_d} and K_{2_d} (S203). The depth calculating unit 11c calculates, using Math. 2, for each of the partial regions A1 to A15, the deviation value map M_{d} based on the frequency characteristic F_{0_d} of the reference depth restored image obtained for each partial region and the frequency characteristics F₁ and F₂ obtained for the partial regions of the captured images f₁ and f₂ (S204). The depth calculating unit 11c calculates the estimated depth d₀ for each pixel referring to a plurality of deviation value maps M_{d} obtained for each of the partial regions A1 to A15 (S205). For example, the depth calculating unit 11c sets, as the estimated depth d₀ of the pixel, a reference depth of the deviation value map M_{d} having the smallest deviation value w_{d}. Consequently, a depth map before noise removal is generated.

The noise removing unit 11e sets, based on the accuracy evaluation values β calculated for the pixels in each of the partial regions A1 to A15, a parameter (a noise determination threshold) for noise determination (S206). For example, the noise removing unit 11e multiplies a maximum value of the accuracy evaluation values β calculated for the pixels in each of the partial regions A1 to A15 by a predetermined percentage (for example, 50%) and sets a result of the multiplication as the parameter (the noise determination threshold) for noise determination. The noise removing unit 11e compares the parameter (the noise determination threshold) set for each of the partial regions A1 to A15 and the accuracy evaluation values β of the pixels included in each of the partial regions A1 to A15. The noise removing unit 11e removes, from the depth map, the estimated depth d₀ determined as noise based on a result of the comparison (S207). For example, the noise removing unit 11e determines, as noise, for example, the estimated depth d₀ calculated for a pixel having the accuracy evaluation value β lower than the noise determination threshold and removes the estimated depth d₀ from the depth map.

In the depth map generation device 10, the control unit 11 acquires the two captured images f₁ and f₂ with the two coded apertures different from each other. In contrast to this, the control unit 11 may acquire three captured images with three coded apertures different from one another. Further, as another example, the control unit 11 may acquire a captured image with one kind of a coded aperture.

The control unit 11 calculates the accuracy evaluation value β for the estimated depth d₀ based on the difference between the maximum and the minimum of the deviation value w_{d} calculated for each pixel. The calculation of the accuracy evaluation value β is not limited to this. For example, the control unit 11 may calculate the accuracy evaluation value β for the estimated depth d₀ based on the minimum of the deviation value w_{d} calculated for each pixel, although the accuracy of the estimation might be deteriorated.

The depth calculating unit 11c may perform various kinds of image processing for the captured images f₁ and f₂. For example, the depth calculating unit 11c may calculate contrast of each partial region after the division processing by the dividing unit 11d was performed. Then, when there is a partial region where contrast therein is lower than a predetermined value and the maximum luminance therein is lower than the predetermined value, the depth calculating unit 11c may execute, for the partial region or the entire captured images f₁ and f₂, image processing for expanding a histogram. This makes it possible to calculate the estimated depth d₀ for a dark partial region.

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A depth map generation device that generates a depth map from a captured image captured through a coded aperture, the depth map generation device comprising:
a depth calculating unit configured to calculate a depth for each of a plurality of unit regions forming the depth map;
a dividing unit configured to divide an image region corresponding to the captured image into a plurality of partial regions including at least a first partial region and a second partial region; and
a noise removing unit configured to remove, using a first parameter, noise from depths calculated for unit regions included in the first partial region, and the noise removing unit configured to remove, using a second parameter, noise from depths calculated for unit regions included in the second partial region.

2. The depth map generation device according to claim 1, wherein the noise removing unit:
calculates an accuracy evaluation value indicating accuracy of the depth calculated for each unit regions;
determines, based on the first parameter and the accuracy evaluation value calculated for each unit region in the first partial region, whether the depth calculated for each unit region of the first partial region is noise; and
determines, based on the second parameter and the accuracy evaluation value calculated for each unit region in the second partial region, whether the depth calculated for each unit region of the second partial region is noise.

3. The depth map generation device according to claim 2, wherein
the first parameter and the second parameter are thresholds for the noise determination, and
the noise removing unit:
determines, based on a comparison result between the first parameter and the accuracy evaluation value calculated for each unit region in the first partial region, whether the depth calculated for each unit region of the first partial region is noise, and
determines, based on a comparison result between the second parameter and the accuracy evaluation value calculated for each unit region in the second partial region, whether the depth calculated for each unit region of the second partial region is noise.

4. The depth map generation device according to claim 2, wherein the noise removing unit:
sets the first parameter based on a plurality of the accuracy evaluation values calculated for the plurality of unit regions in the first partial region; and
sets the second parameter based on a plurality of the accuracy evaluation values calculated for the plurality of unit regions in the second partial region.

5. The depth map generation device according to claim 1, wherein the depth calculating unit:
acquires a plurality of Point Spread Functions (PSFs) respectively corresponding to an aperture pattern of the coded aperture and corresponding to a plurality of reference depths defined discretely;
calculates a deviation value for each unit region based on the captured image and a plurality of reference depth restored images, where the deviation value represents a deviation degree between the reference depth and an actual depth, and the plurality of reference depth restored images is reproduced from the captured image respectively by using the plurality of PSFs; and
calculates a depth for each unit region based on the deviation value.

6. The depth map generation device according to claim 5, wherein the noise removing unit calculates, based on the deviation value calculated for each unit region, an accuracy evaluation value indicating accuracy of the depth calculated for each unit region.

7. The depth map generation device according to claim 6, wherein the deviation values calculated for each unit region are values that change depending on the reference depths, and the noise removing unit calculates the accuracy evaluation value based on widths of changes in the deviation values calculated for each unit region.

8. The depth map generation device according to claim 7, wherein the noise removing unit:
sets the first parameter based on a plurality of accuracy evaluation values calculated for the plurality of unit regions in the first partial region; and
sets the second parameter based on a plurality of accuracy evaluation values calculated for the plurality of unit regions in the second partial region.

9. A method of generating a depth map from a captured image captured through a coded aperture, the depth map generation method comprising:
a depth calculating step for calculating a depth for each of a plurality of unit regions forming the depth map;
a dividing step for dividing an image region corresponding to the captured image into a plurality of partial regions including at least a first partial region and a second partial region; and
a noise removing step for removing, using a first parameter, noise from depths calculated for a plurality of unit regions included in the first partial region, and the noise removing step for removing, using a second parameter, noise from depths calculated for a plurality of unit regions included in the second partial region.

10. A non-transitory information storage medium storing a program for causing a computer to function as a device for generating a depth map from a captured image captured through a coded aperture, the program causing the computer to function as:
depth calculating means for calculating a depth for each of a plurality of unit regions forming the depth map;
dividing means for dividing an image region corresponding to the captured image into a plurality of partial regions including at least a first partial region and a second partial region; and
noise removing means for removing, using a first parameter, noise from depths calculated for a plurality of unit regions included in the first partial region and the noise removing means for removing, using a second parameter, noise from depths calculated for a plurality of unit regions included in the second partial region.
